(19) United States
(12) Patent Application Publication
(10) Pub. No.: US 2006/0151068 A1
(43) Pub. Date: Jul. 13, 2006

(54) Production method of Fe-based soft magnetic powders for high frequency and soft magnetic core using the powders

(76) Inventors: Kee Sun Lee, Daejeon Metrpolitan City (KR); Jin Kwon Kim, Daejeon Metropolitan City (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,320

(22) Filed: Jan. 6, 2006

(30) Foreign Application Priority Data
Jan. 11, 2005 (KR) 10-2005-2661

(51) Int. Cl. H01F 1/147

(52) U.S. Cl. 148/104

(57) ABSTRACT

Disclosed is a method of manufacturing Fe-based soft magnetic powder for a high-frequency application. The method includes the steps of manufacturing Fe-9Al-6Si alloy powder; deforming the Fe-9Al-6Si alloy powder into a flake-like form using a high energy ball mill, and heat-treating the flake-like Fe-9Al-6Si alloy powder to relieve stress and be re-crystallized to have a super fine grain size. 0.1˜5 weight percent of lubricant with respect to the alloy powder and balls of the high energy ball mill is added during the ball mill processing. A soft magnetic core made of the Fe-based powder is also disclosed.

### CROSS REFERENCE TO RELATED APPLICATION

This application claims priority under 35 USC § 119 to Korean Patent Application No. 2005-0002661, filed on Jan. 11, 2005, the contents of which are incorporated herein by reference in their entirety.

### BACKGROUND OF THE INVENTION

1. Field of the Invention

The present invention relates generally to a method of manufacturing Fe-based soft magnetic powder and a soft magnetic core using the soft magnetic powder. More specifically, the invention relates to a method of manufacturing Fe-based soft magnetic power and a soft magnetic core using the powder, in which Fe-9Al-6Si powder is deformed into a flake-like form to have a superfine microstructure and then fabricated into a soft magnetic core having less expensive and good high-frequency characteristics as compared with a Ni-based powder core, thereby being applied to a high-performance micro soft magnetic component, such as a high-frequency power supply, a pulse transformer, a removal of electromagnetic noise, an electromagnetic shield, a supersaturated core, and a magnetic switching core.

2. Background of the Related Art

In general, a high-frequency soft magnetic component has been made mainly of Ni—Fe permalloy, soft ferrite and amorphous alloys having a high magnetic permeability at high frequencies and a low permeability loss, and is categorized into a wound core of thin metallic strip and a press-formed powder core.

The materials for this powder core is classified into metals and oxides. The metals such as 80Ni-20Fe (permalloy), Fe-9Al-6Si (sendust), and 50Fe-50Ni (high flux) have a high saturation magnetization and do not cause a significant reduction in the initial permeability under DC-bias, thereby exhibiting a stable property of permeability and enabling a miniaturized core. In case of a powder core, in order to reduce core loss at high frequencies and maintain a stable permeability, the core may contain air gap of about 10˜20% inside thereof. The metallic core can be easily fabricated through press-forming, but the oxide core has relatively poor formability, which results in difficulties of fabrication. Thus, the metallic powder core is preferred as magnetic core components.

The metallic powder core is formed typically of 80Ni-20Fe (permalloy), Fe-9Al-6Si (sendust), and 50Fe-50Ni (high flux), and manufactured through the following process.

First, a spherical powder is manufactured through a gas atomizing method, and the particle size of the power is in a range of several tens to several hundreds microns. In addition, the grain size of the powder is in a range of a few to few tens microns. The manufactured powder is partially coated with an insulation film through an oxide coating process. In many cases, the powder is mixed with water glass in an appropriate ratio, and dried and heat-treated to thereby coat silica on the surface of the powder particle. These are press-formed to make a magnetic core, the magnetic property of which is shown in FIG. 1.

The powder core made of permalloy has a saturation magnetization of about 0.7 T, a high permeability at a high frequency range as compared with other competitive materials, and exhibits a good stability of permeability with frequency change. This core has a good mechanical ductility to thereby provide an advantage of easy press-forming. However, the constituent metallic element, nickel, is expensive, which results in high price of the core products.

The Sendust core has a saturation magnetization of about 1.2 T and a relatively low permeability at a high frequency range as compared with other competitive materials, but has a similar stability of permeability with frequency change to the permealloy. This core is mechanically brittle and thus difficult in press-forming disadvantageously. However, the constituent elements are less expensive and thus the core products are also less expensive.

The high flux core has a high saturation magnetization of about 1.2˜1.4 T and a low permeability at high frequencies as compared to other competitive materials. Comparing with other materials (Permalloy and Sendust), it has the lowest stability of permeability with frequency change. This core has a mechanical ductility and thus its press-forming is relatively easy. The constituent metallic element, Ni, is expensive and thus the core products are expensive.

Typically, the above existing powder cores have a large particle size and a large grain size and the powder particles have a spherical shape. The core is provided with air gap inside thereof to thereby provide a low permeability loss at high frequencies and secure initial permeability in a stable manner advantageously. However, at a high frequency of above 10 MHz, its permeability remains at a lower value of less than about 30 so that the core size cannot be reduced. This problem has become a limiting factor to miniaturize the cores for high-frequency implementation.

### SUMMARY OF THE INVENTION

Therefore, the present invention has been made in view of the above problems in the art, and it is an object of the present invention to provide a method of manufacturing a Fe-based soft magnetic powder for high-frequency implementations and a soft magnetic core using the powder, in which a less expensive Fe-based alloy powder is deformed into a flake form to minimize the demagnetizing factor and have a superfine microstructure, thereby improving production efficiency and high-frequency characteristics, as compared with a Ni-based power core.

To accomplish the above object, according to one aspect of the present invention, there is provided a method of Fe-based soft magnetic powder for a high-frequency application, the method comprises the steps of: (a) manufacturing Fe-9Al-6Si alloy powder; (b) deforming the Fe-9Al-6Si alloy powder into a flake-like form; and (c) heat-treating the flake-like Fe-9Al-6Si alloy powder to relieve stress and be re-crystallized to have a super fine grain size.

In the step (a), the Fe-9Al-6Si alloy powder is manufactured, preferably, through a gas atomizing or water atomizing process, but not limited thereto. In the step (b), the formation of the Fe-9Al-6Si alloy powder into a flake-like form is carried out, preferably, using a high-energy ball mill.

The flake-like Fe-9Al-6Si alloy powder deformed in the step (b) has a high density of dislocations since the lattice of the alloy powder is severely distorted. In the step (c), the heat-treatment is performed to re-crystallize the deformed powder to have a nano-scale grain size.

According to another aspect of the invention, there is provided a soft magnetic core using a Fe-based soft magnetic powder for high frequency applications manufactured according to the above method, wherein the Fe-based soft magnetic powder is mixed with a binder, the mixture is press-formed and heat-treated.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is graphs plotting frequency versus permeability for various commercialized soft magnetic powder cores;

FIG. 2 is a SEM photo of Fe-9Al-6Si powder manufactured through a gas atomizing process;

FIG. 3 is a SEM photo of Fe-9Al-6Si powder manufactured according to a first embodiment of the invention;

FIG. 4 shows XRD spectrum for Fe-9Al-6Si powder manufactured according to the first embodiment of the invention;

FIG. 5 are graphs explaining a change in the grain size of Fe-9Al-6Si powder manufactured according to the first embodiment of the invention;

FIG. 6 shows a soft magnetic core press-formed according to the present invention; and

FIG. 7 is a graph showing variation of permeability with frequency for a Fe-9Al-6Si soft magnetic powder core of the invention.

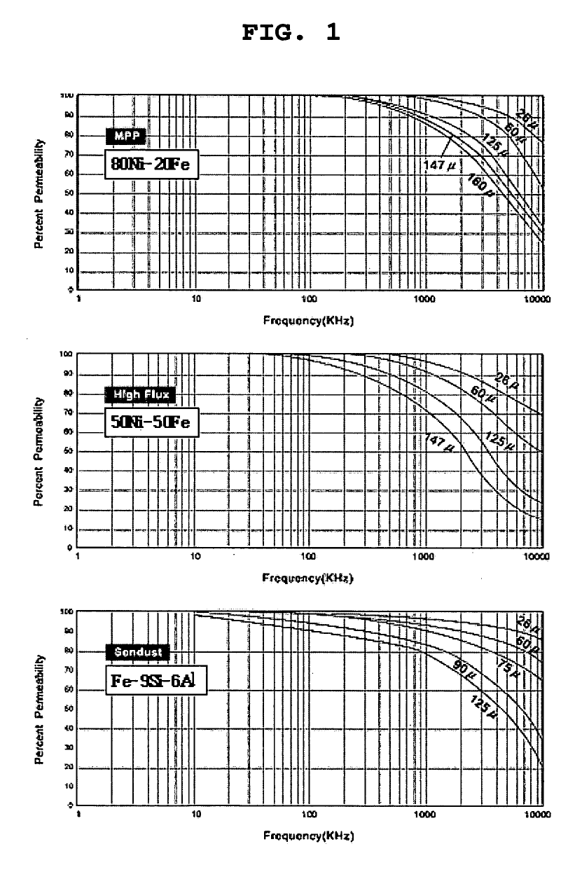

### DETAILED DESCRIPTION OF THE PREFERRED EMBODIMENTS

The preferred embodiments of the invention will be hereafter described in detail, with reference to the accompanying drawings.

The embodiments of the invention will be explained, illustrating Fe-9Al-6si alloys.

### 1. First Embodiment (Manufacturing of Flake-Like Fe-9Al-6Si Alloy Powder)

(1) Preparation of Fe-9Al-6Si Alloy Powder

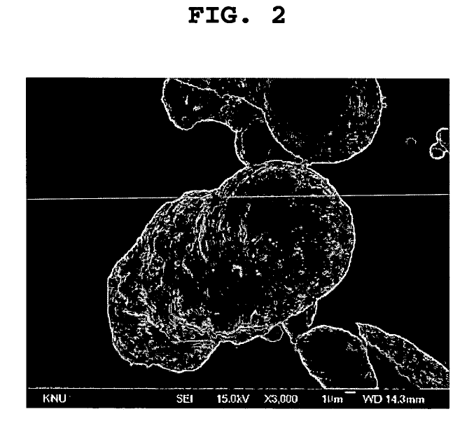

Fe-9Al-6Si alloy powder was manufactured using a gas atomizing process. The manufactured Fe-9Al-6Si alloy powder exhibited a spherical shape as shown in FIG. 2.

(2) Manufacturing of Flake-Like Fe-9Al-6Si Alloy Powder

(a) 50 g of the spherical Fe-9Al-6Si alloy powder was charged into a stainless steel container of a high energy ball mill with 1 kg of stainless steel balls.

The weight ratio of the Fe-9Al-6Si alloy powder to the stainless steel ball is preferably 1:20. The lower weight ratio leads to an extended period of time, and the higher weight ratio can shorten the time.

In this embodiment, 1 weight % of stearic acid was added as a lubricant. In the case where the stearic acid was added less than 0.1%, the Fe-9Al-6Si power could not be deformed in a flake-shape, due to severe pressure-bonding among the power particles. Above 5% of stearic acid is excessive for preventing the pressure-bonding. Thus, 0.1˜5 weight % with respect to the charged powder and the balls is preferred. In addition, this embodiment employed a solid lubricant, but not limited thereto, for example, a liquid lubricant such as ethyl alcohol and trichloroethyl alcohol may be used.

Dissimilar to a conventional method where the lubricant is used in a limited way to maximize the pressure-bonding effect among the powder particles, in the present invention, the amount of the lubricant was controlled to minimize the pressure-bonding among the Fe-9Al-6Si powder particles and maximize pressurizing effect between the separate powder particles and the steel ball, thus obtaining a flake-like powder.

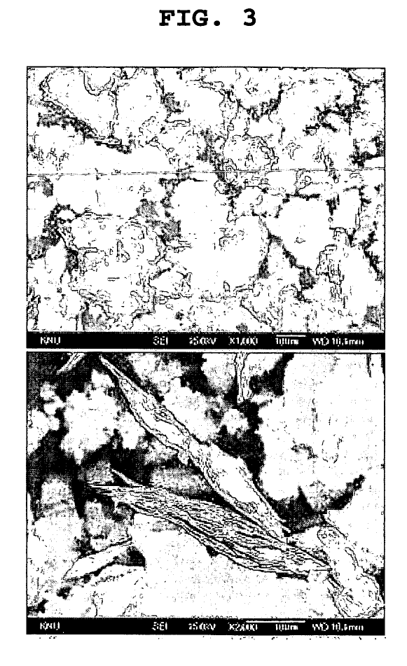

(b) The high energy ball mill was operated for one hour to deform the spherical Fe-9Al-6Si alloy powder into flake-shaped Fe-9Al-6Si alloy powder, which is shown in FIG. 3.

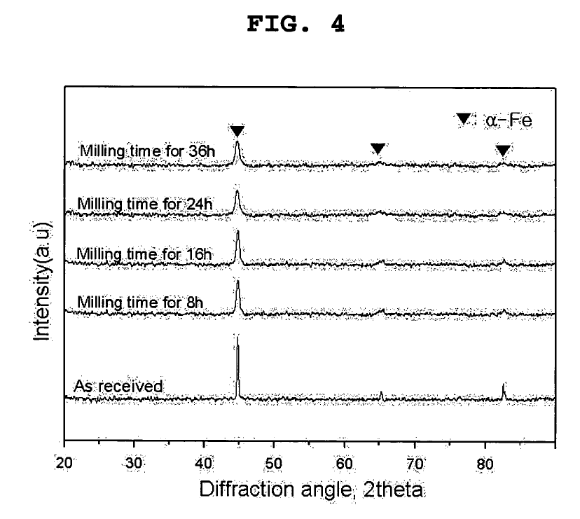

FIG. 4 is a graph showing XRD (X-ray diffraction) peak of Fe-9Al-6Si alloy powder with variations of milling time, after heat-treating as in the embodiment 2. As shown in FIG. 4, it has been found out that the width of X-ray diffraction peak is widened and the intensity thereof is decreased as the milling time increases.

On the other hand, the reasons why the spherical Fe-9Al-6Si alloy powder is converted into flake-form and simultaneously into superfine microstructure through the high-energy ball mill process are as follows.

When gas-atomized spherical Fe-9Al-6Si alloy powder is processed using a ball mill without meeting the above conditions, pressure-bonding severely occurs and the pressure-bonded powder is again crushed into spherical powder particles. Thus, the ball-mill process is to be carried out under the above conditions, i.e., an appropriate time of mechanical crushing and addition of lubricant can provide a flake-form powder.

During this course of processes, the flake-like Fe-9Al-6Si alloy powder comes to have a fine structure while causing partial cracking, and experiences severe plastic deformation to increase the density of dislocations by means of the ball-mill process to thereby store elastic deformation. In addition, the powder is transformed into nano-size grains through the heat-treatment as in the following third embodiment.

### 2. Second Embodiment (Heat-Treatment of Flake-Form Fe-9Al-6Si Alloy Powder)

In order for the flake-form Fe-9Al-6Si alloy powder prepared in the first embodiment to have a nano-structure, a heat-treatment is required. The alloy powder is not crystallized at a temperature less than 300° C. and causes a grain growth at a temperature of above 800° C. Thus, it is preferable that the heat-treatment is performed in a range of 300˜800° C. Although it varies with the grain size of the Fe-9Al-6Si alloy powder, the minimum time for crystallization is at least 10 minutes and the grain growth occurs more than 5 hours. In this embodiment, the heat-treatment was performed for 1˜3 hours at 600° C.

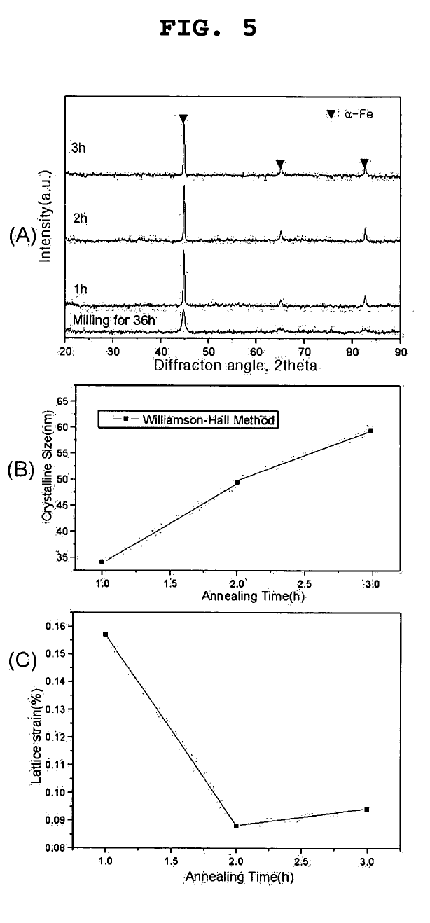

The Fe-9Al-6Si alloy powder mill-processed for 36 hours was heat-treated under the above conditions. As the result, as shown in FIG. 5(A), the peak intensity representing crystallization was found to be increased as the heat-treating time increases. As a result of calculating the grain size and the lattice strain energy using the Williamson-Hall method, the gain size was controlled to about 60 nm at 3 hours of heat-treatment, as shown in FIG. 5(B). As shown in FIG. 5(c), the lattice strain was reduced to 0.09% from 0.16% when the heat-treating time (annealing time) was increased to 2, 3 hours from 1 hour.

### 3. Third Embodiment (Fabrication of Soft Magnetic Core Using Flake-Form Fe-9Al-6Si Alloy Powder)

(1) A binder such as 0.1˜3% water glass or polyimide was added into the flake-form Fe-9Al-6Si alloy powder prepared in the second embodiment and mixed together using a ball mill.

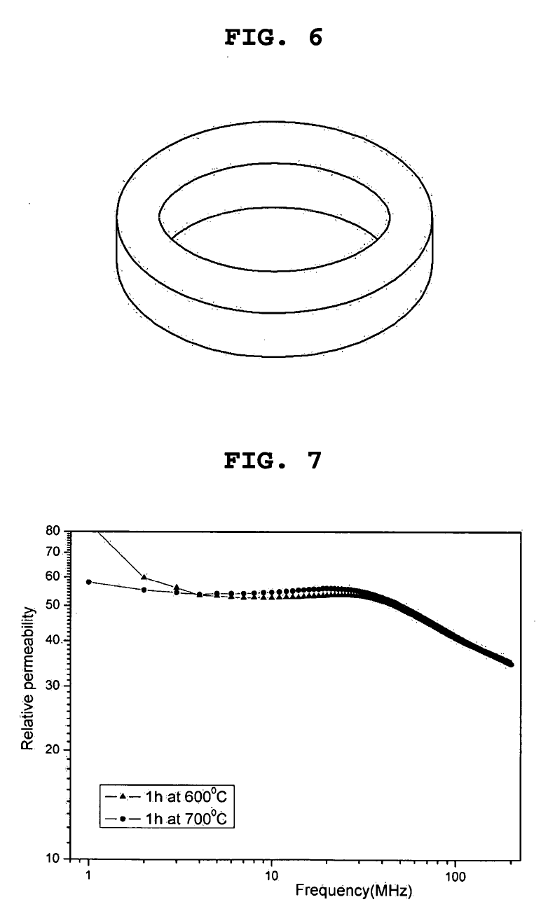

(2) The mixture of the Fe-9Al-6Si alloy powder and the binder was press-formed under a pressure of 10 Ton/cm² to fabricate an annular core as shown in FIG. 6.

At this time, depending upon the forming pressure, various annular cores having the apparent density of 50˜90% can be fabricated. The density of the fabricated core was measured using the Archimedes principle.

(3) The press-formed core was heat-treated at a range of 300˜800° C. to release stress.

At this time, below 300° C., the stress release is not adequate and, above 800° C., grain growth occurs due to contact among powder particles.

FIG. 7 shows magnetic property of the core of the invention. As shown in FIG. 7, the permeability is above about 50, and remains constant until 50 MHz. At 100 MHz, it exhibited permeability of above 40. These results are very excellent, exceeding the magnetic property of the conventional Permally core containing high-cost nickel.

As described above, according to the present invention, spherical Fe-9Al-6Si alloy powder is transformed into flake-form Fe-9Al-6Si alloy powder to minimize demagnetizing factor being caused by the spherical powder. Superfine microstructure can be achieved through a heat-treatment of the flake-form alloy powder to improve permeability, which is maintained at a high-frequency range, as compared with conventional powders.

The heat-treated flake-form Fe-9Al-6Si can be press-formed into a powder core. In addition, the present invention can be applied to a soft magnetic material for ultrahigh frequency application, such as a chip inductor capable of low-temperature plasticity using a tape casting.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of Fe-based soft magnetic powder for high-frequency applications, the method comprising the steps of:
(a) manufacturing Fe-9Al-6Si alloy powder;
(b) deforming the Fe-9Al-6Si alloy powder into a flake-like form using a high energy ball mill, where 0.1˜5 weight percent of lubricant with respect to the alloy powder and balls of the high energy ball mill is added during the ball mill processing; and
(c) heat-treating the flake-like Fe-9Al-6Si alloy powder to relieve stress and be re-crystallized to have a super fine grain size.

2. The method as claimed in claim 1, wherein the lubricant is one selected from the group consisting of stearic acid, ethyl alcohol, and trichloroethyl alcohol.

3. The method as claimed in claim 1, wherein the heat-treating step (c) is performed for from 10 minutes to 5 hours at the temperature range of 300˜800° C.

4. A soft magnetic core using a Fe-based soft magnetic powder for high frequency applications manufactured according to the method as claimed in claim 1, wherein the Fe-based soft magnetic powder is mixed with a binder, the mixture is press-formed and heat-treated.
